(19) United States
(12) Patent Application Publication
(10) Pub. No.: US 2001/0041601 A1
(43) Pub. Date: Nov. 15, 2001

(54) Rewinding device for mobile phones

(76) Inventors: Paolo Benelli, Arezzo (IT); Mario Chiarenza, Chiusi Della Verna - Arezzo (IT)

Correspondence Address: YOUNG & THOMPSON, 745 SOUTH 23RD STREET 2ND FLOOR, ARLINGTON, VA, 22202

(21) Appl. No.: 09/731,020

(22) Filed: Dec. 7, 2000

(30) Foreign Application Priority Data
Jan. 5, 2000 (IT) AR2000 U 000001

(51) Int. Cl. H04B 1/38

(52) U.S. Cl. 455/568; 455/90; 455/575; 455/569

(57) ABSTRACT

The invention consists in a box like structure (1) equipped on the inside with a winding group (2) and, on the outline, with at least two imprints (3) and (4) appropriately shaped to house the microphone (5) and earpiece (6) as well as a groove (7) to lodge the piece of wire (8) which joins them, therefore with a junction placket (9) for the electric coupling with the mobile phone and, on the back side, with elastic lengthening means (20) for the stabilization of said coupling.

### BACKGROUND OF THE INVENTION

The invention concerns a wire winding device for mobile phones, aimed at allowing at least to place the mobile phone and its emission antenna far from the head of the user.

Mobile phones, equipped with a receiving/transmitting antenna which emits, into the surrounding space, electromagnetic waves which are particularly intense near it, are very common.

It is also a common belief that intense electromagnetic fields provoke ailments, or in any case dangerous effects, to the human body when it is invested by said fields frequently or for prolonged periods of time.

As a consequence of this belief an accessory device, which allows the use of the mobile phone by keeping it far from the user's head, has been created.

An accessory device constituted of an electric wire equipped on one end with a connector which joins it electrically to the mobile phone, on the other end it is equipped with an earpiece, a microphone and an anchoring clip for the placement of the microphone. Said accessory device, when not in use, is particularly bulky and, when placed in the pocket, is capable of tangling easily with other objects, such as, for example, keys, lighter, cigarettes, the handkerchief and any type of object contained in the same pockets.

On the other hand, when the mobile phone is turned off, or when the user is in private areas, it is not useful to keep the wire in the position of use, that is why it is detached and placed normally in the pockets.

Along with a noticeable clutter, this causes the possibility of damaging said device, or in any case that it can tangle with the other objects contained in the user's pockets, with problems for its separation when the wire with the transducers must be re-used.

In order to overcome this inconvenience it was necessary to create a device within which to collect the wire equipped, on one end with a connector to the mobile phone, on the other with a clip for anchoring it on the user's clothes and with the two transducers: the earpiece and the microphone.

At the present state of the art, a rewinding unit capable of collecting inside its structure, a connector and an earpiece joined together by a wire and used for stereophonic cassette and CD players by means of a headphone or earpiece (walkman), is known.

This type of rewinding group is a separate body which is detachable from the wire equipped with the connector and transducers when the latter are in use, which results in a cumbersome item to transport, with the consequent handicaps.

### SUMMARY OF THE INVENTION

The aim of the present invention is the production of a device which:

is capable of housing the wire and the transducers in an orderly way, preventing them, when rewound, from tangling with other objects;

occupies the minimum space and allows to predispose the use of the wire and transducers with an easy and quick manoeuvre;

does not have parts that must be kept in the pocket when in use;

Is an extension of the mobile phone, when it is in use as well as when it is not in use.

The invention that has allowed the achievement of these results is made of a box like structure equipped on its inside with a winding group and on the contour with at least two indentations capable of housing the microphone and the earpiece, as well as with a groove for housing the wire that joins them, therefore with an opening from which emerges a junction placket for the electric connection to the mobile phone. Finally, said box like structure is equipped, on the back side, with an elastic extension for its mechanical joining to the mobile phone and for the stabilisation of the electric connection of the junction placket.

This type of invention is advantageous because the wire that carries the microphone and earpiece, when it is not in use, is re-absorbed into the box like structure from which it emerges, without jutting parts which can tangle with other objects. Another advantage comes from the fact that, when it is applied to the mobile phone, it can remain joined to the same even when the wire with the microphone and earpiece is rewound inside it.

Still another advantage comes from the fact that, when it is connected to the mobile phone, it does not have detached parts that must be stored in the pockets.

### BRIEF DESCRIPTION OF THE DRAWINGS

The invention will be easily understood in its structure and function by following the detailed description which follows and which refers to the real shape that is exemplified in the drawings, in which:

FIG. 1 is the schematic sectioned front view of the invention showing the winder, the cavities housing the microphone and the earpiece as well as the junction placket with the electric connection elements;

FIG. 2 is the front view of the invention with the microphone and earpiece extracted from their housing;

FIG. 3 is the side view of the invention in which the earpiece is shown housed in the appropriate imprint;

FIG. 4 is the side view of the invention showing the posterior means, capable of stabilising the connection to the mobile phone, reproduced in a closed position;

FIG. 5 is the front view from the back part of the invention joined to the mobile phone, with the junction stabilisation means shown.

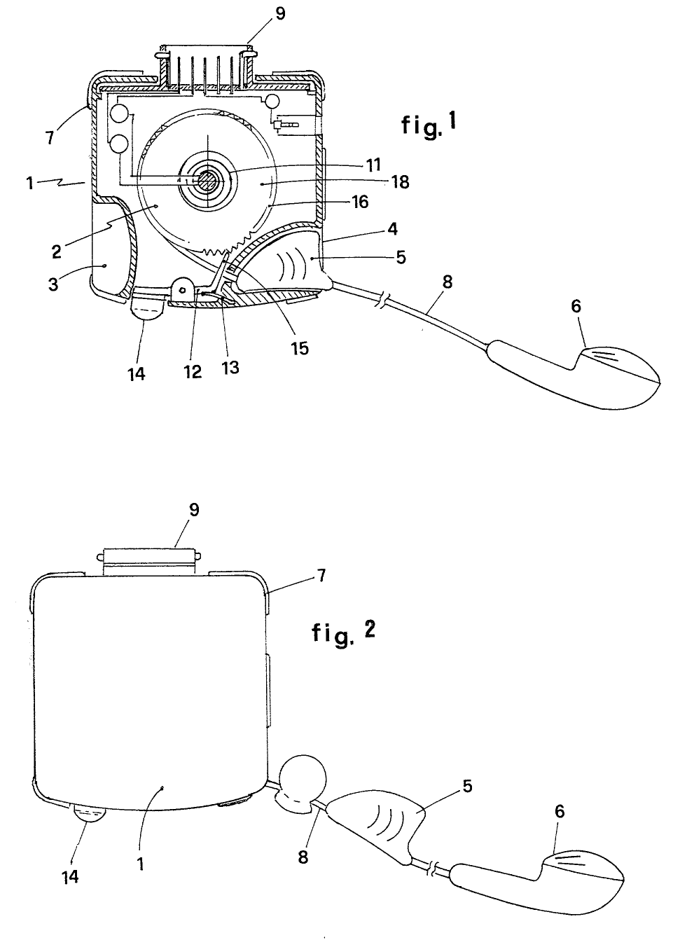

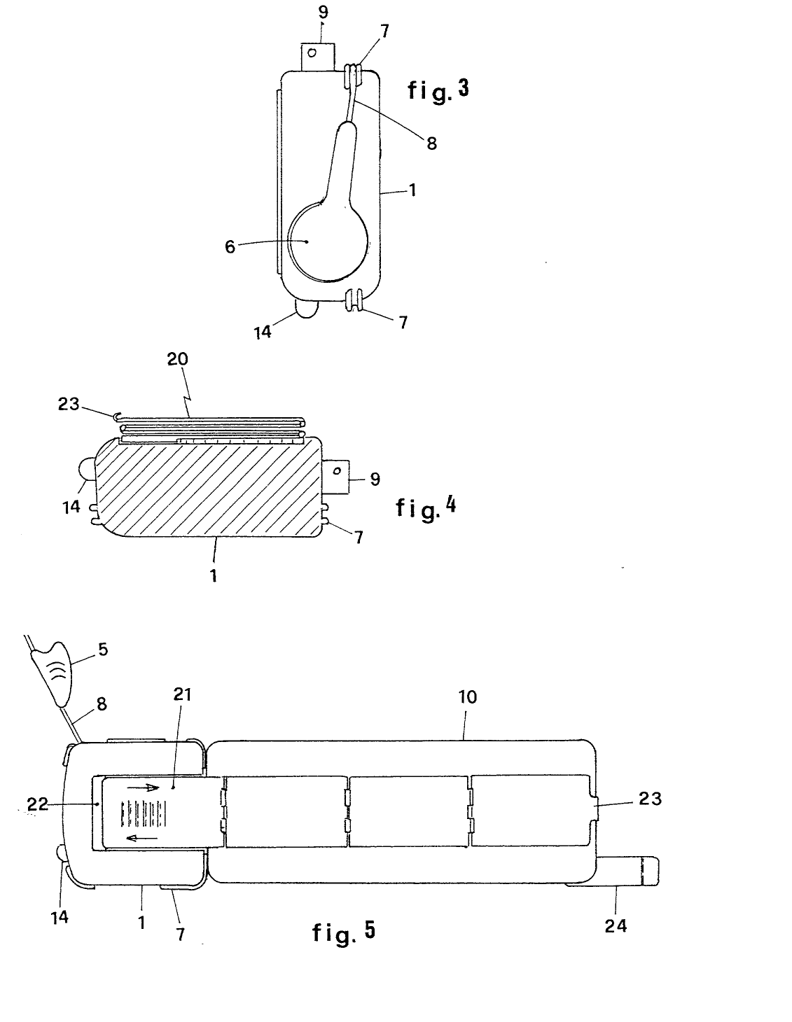

### DESCRIPTION OF THE PREFERRED EMBODIMENT(S)

It must be understood that the drawings have only a schematic and exemplifying character with the aim of facilitating understanding of the same invention, without constituting any limitation to it.

The invention consists therefore of a wire winding device for mobile phones, through which it is possible to move the mobile phone 10 from the auxiliary microphone 5 and the earpiece 6, in such a way as to keep, the radiating source 24 of the electromagnetic waves, away at least from the head of the user.

Said device is constituted by the box like structure 1, housing inside it the winding group 2, normally consisting of a drum equipped with a loaded spring 11, the latter capable of causing the recall of the electric wire 8 and its rewinding around the same drum, so that the wire assumes the resting position which corresponds to the wound up state.

Said winding group 2 is equipped with braking means with which to block its rotation in the chosen position. For example in the position corresponding to the extended state of the electric connection wire 8, as in the case in which the earpiece 6 is inserted in the user's ear, while his belt holds the mobile phone 10 with the invention connected to it.

Said braking means are constituted by the lever 12 pushed towards the blocked state by the spring 13, which on one end is equipped with a jutting activation button 14. On the other extremity it ends with a tab 15 capable of entering into the cog wheel 16 of the disc 18, that is coaxial to the winding drum, or with a tab that is capable of a guillotine braking action on the same wire, which, in this case, runs on a contrast surface.

The winding drum is integrated with the extremities of the conductors housed inside the wire 8 and which are connected at the other extremity to the microphone 5 and earpiece 6. By means of ring contacts rubbing on the conductors of the wire 8 they are connected to the fixed terminals on which the corresponding electric contacts of the junction placket 9 are fixed.

The latter is an element that is slotted into the box like structure 1 and therefore can be substituted with another to make it capable of joining with different mobile phones, with which it is projected to interact.

In the containment structure 1 there are at least two indentations 3 and 4 capable of housing the earpiece 6 and the microphone 5 when they are not in use. The box like structure 1 also has, on the outline, appropriate projections 7, shaped as a groove, capable of holding the part of the wire 8 which joins the microphone 5 and the earpiece 6 so that, when they are not in use, the invention consists in a compact structure, devoid of hanging parts.

The back surface of the containing structure 1 has the junction mechanisms, normally a type of folding structure like a book 20, with the base 21 running on a track 22, impeded in its movements by a spring. The junction mechanisms 20 end with a tab 23 shaped so as to join with the corresponding seat on the mobile phone 10 and to make the connection with the junction placket 9, jutting from the invention, stable and secure with the corresponding one of the same mobile phone.

In the production phase the parts shown in the drawings could undergo some minor modifications or can be substituted with equivalent elements, which in any case fall within the area of protection of the following claims.

1. A winding mechanism for mobile phones, aimed at allowing the placement of the mobile phone (10) and its radiating antenna (24) away at least from the head of the user, characterised by a structure (1) bearing inside a winding group (2), on the outline at least the imprints (3) and (4), shaped appropriately to house the earpiece (6) and microphone (5), as well as an opening from which emerges the junction placket (9) for the electric joining to the mobile phone (10) and, on the back, characterised by the elastic junction means (20) for the stabilisation of the connection of the invention to the mobile phone.

2. The device, as claimed in claim 1, characterised by a winding group (2), equipped with a loaded spring (11), capable of recalling the electric connection wire (8) around its drum.

3. The device, as claimed in claim 1, characterised by the fact that the winding group (2) is equipped with braking means with which to block its rotation in the chosen position, to which corresponds the extended state of the connecting wire (8).

4. The device, as claimed in claim 1, characterised by a winding group (2) equipped with electric contacts capable of connecting one extremity of the electric wire (8) with the corresponding electric contacts on the junction placket (9).

5. The device, as claimed in claim 1, characterised by the fact that the junction placket (9) is of that type that can be substituted to adapt to the mobile phone (10) with which it must be joined.

6. The device, as claimed in claim 1, characterised by the fact that on the containment structure (1) there are at least two imprints (4) and (3) capable of housing the microphone (5) and the earpiece (6) placed at the free extremity of the connection wire (8).

7. The device, as claimed in claim 1, characterised by the fact that the connecting means (20) are of the folding type like a book, with their base (21) sliding on the track (22), impeded by a spring.
